(19) United States
(12) Patent Application Publication
(10) Pub. No.: US 2026/0240369 A1
(43) Pub. Date: Aug. 20, 2026

(54) REFINE PRO

(71) Applicant: RICARDO ANTHONY MCBEAN, WEST PARK, FL (US)

(72) Inventor: RICARDO ANTHONY MCBEAN, WEST PARK, FL (US)

(21) Appl. No.: 18/831,996

(22) Filed: Jan. 12, 2026

Related U.S. Application Data
(60) Provisional application No. 63/744,122, filed on Jan. 10, 2025.

(51) Int. Cl. A47J 43/07; A47J 43/046

(52) U.S. Cl. CPC A47J 43/0722; A47J 43/046

(57) ABSTRACT

A type of blender that breaks down food my means of both chopping and grinding, It includes; a textured area or surface of the bottom of the blender jar that is in close proximity of the rotational path of at least one blade, said textured area is close to said rotational path of said blades by; being on a gradual raised area such that food can be channel upwards between it and said blades, or said textured area is on a level surface of said bottom of jar, and at least one said blade is at a low position and angled or has a bulge such that food is channeled downwards between it and said texture area. Said textured area is either on; an extension of the head or top of a blade assembly, a device with an opening such that it is fitted beneath said blade assembly or an extension, or part of, of said surface of said bottom of said blender jar.

### FIELD OF INVENTION

The present invention relates to blenders, specifically, an improvement that causes it to grind food while cutting/chopping.

### BACKGROUND OF INVENTION

There are countless improvements of blenders of the prior arts, but these improvements, though some more effective than others, all seem to follow the same pattern of changing the shape of the jar, the shape and angles of the blades and/or increasing the size or power of the motor. The present invention, however, is an addition of a device that works alongside the blades such that food is forced between it and the blades to break down said food in a grinding method alongside the traditional cutting/chopping method of the rotating blades.

### BRIEF DESCRIPTION OF DRAWINGS, FIGS. 1-7

FIG. 1 shows a plan view of the preferred embodiment of the blades which are positioned above a grinder disc device having a texture along its diameter.

FIG. 2 show a side view of the preferred embodiment, which further shows the edge of each blade having a right-angle curve and a texture underneath, and the textured portion of the grinder disc is at a peak along its center

FIG. 3 shows plan view of the preferred embodiment with the blades positioned differently.

FIG. 4 show another side view of the preferred embodiment from a different angle.

FIG. 5 show an alternative embodiment with perspective view of parts of a blade system in order of assembly; which includes a set of rotatable blades above a grinder disc device

FIG. 6 show a side view of the parts of said alternative embodiment; assembled within a jar.

FIG. 7 shows a plan view of the assemble blade system of the alternative embodiment.

### SPECIFICATION

In these embodiments the basic and fundamental functions that will transform the blender into a grinder blender is on, or assembled beneath, the blade assembly.

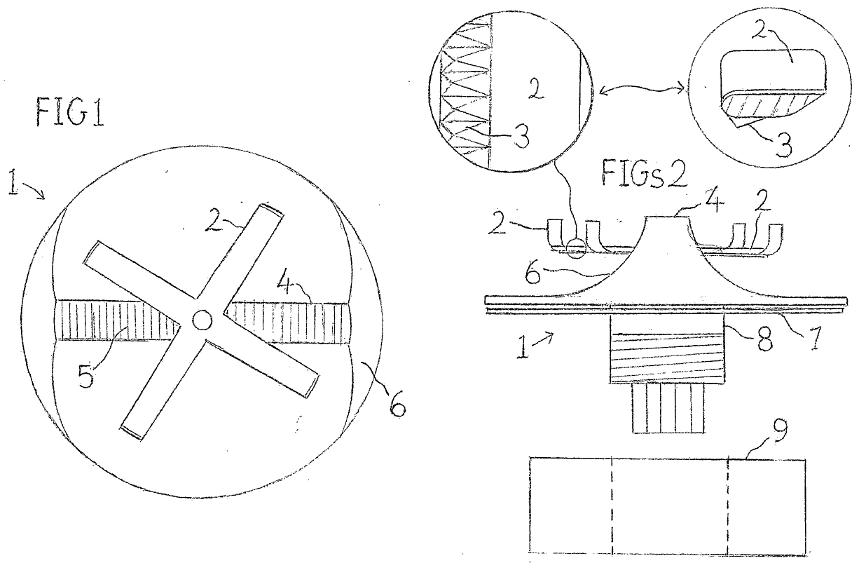

FIG. 2 shows an side view of a blade assembly 1, that has an upper portion 6, specifically; it is the portion that sits in the jar and is circular and wide covering about ⅔-¾ of the bottom of the blender jar, it has a wave like or gradual peak 4 design that extends along its diameter and tappers off into two low areas on each side of the peak 4. FIG. 2 side view, and FIG. 1 plan view shows the blade assembly 1 having four blades 2. FIG. 1 and FIG. 2 further show the peak 4 is flat at the top along its length and has a texture of elongated teeth 5 that extends along the width of the entire flat area 4. Beneath the head 6 blade assembly 1 is shaft body 8 having threading in the middle and a drive gear at its end, said shaft 8 is fitted with a gasket 7. The head portion 6 along with the gasket 7 beneath will sit inside the blender jar, while the shaft 8 with the threading will extend through a hole in the jar, where it is fixed tightly in place by being fitted beneath with an end plate 9 having inner threading matching that of the shaft 8.

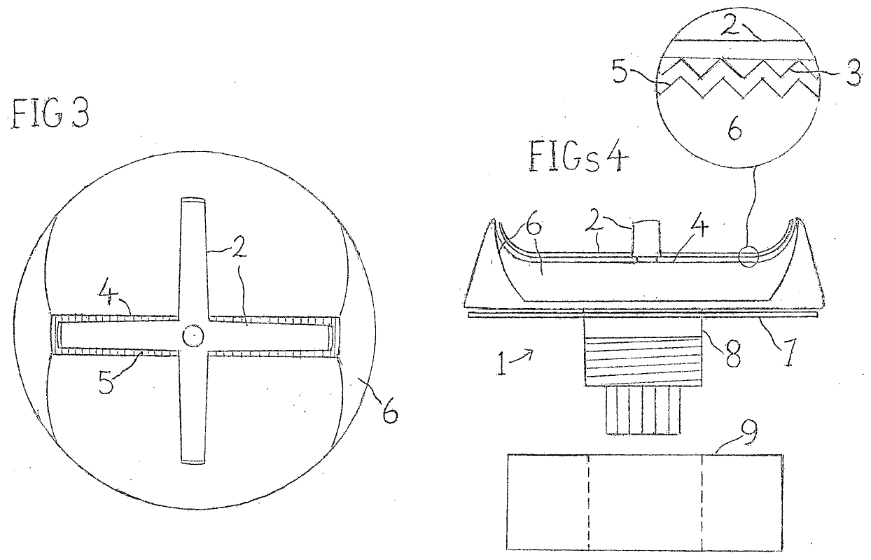

Seen in FIG. 2, at the top, are two exploded views of beneath the blades; a bottom view on the left, and cut away end view on the right, they both show teeth 3 that contours to the elongated teeth 5 of the flat area of the peak 4. Both exploded views show these teeth 3 beneath the blades are an elongated pyramid raisings that are closer to edge of each blade; on the side that is opposite to the spin direction of said blades. FIG. 4 shows a side view of the blade assembly 1 where the blade 2 is positioned directly above the flat area of the peak 4. note that at this position, the space between the blade and the flat area of the peak is small. Directly above is an exploded view; that shows how the pyramid teeth 3 on the bottom of each blade; contours to the elongated teeth 5 of the flat area of the peak 4. FIG. 3 shows a plan view of the blade assembly 1, also with blade directly above the flat area of the peak 4.

### Procedure

Whenever the blade 2 rotates and chops food; the food is cycled with a force along the low area up to the flat area of the peak 4; and at intervals where the blades 2 pass directly above the flat area of the peak 4; food between both is broken down due to being forced through the small space between them and by being grinded on the teeth 3 and 5 of the blade and flat area of peak 4.

### Alterative Embodiment

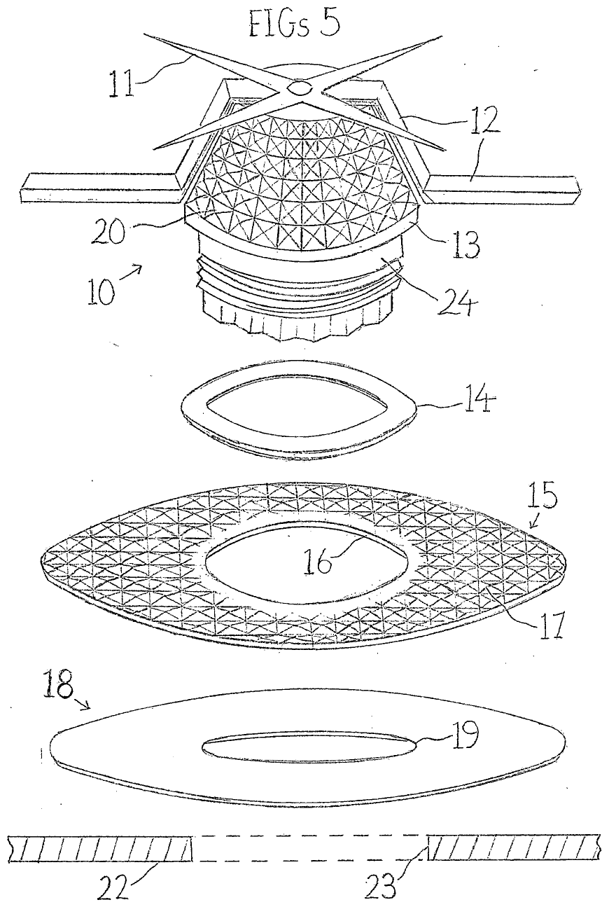

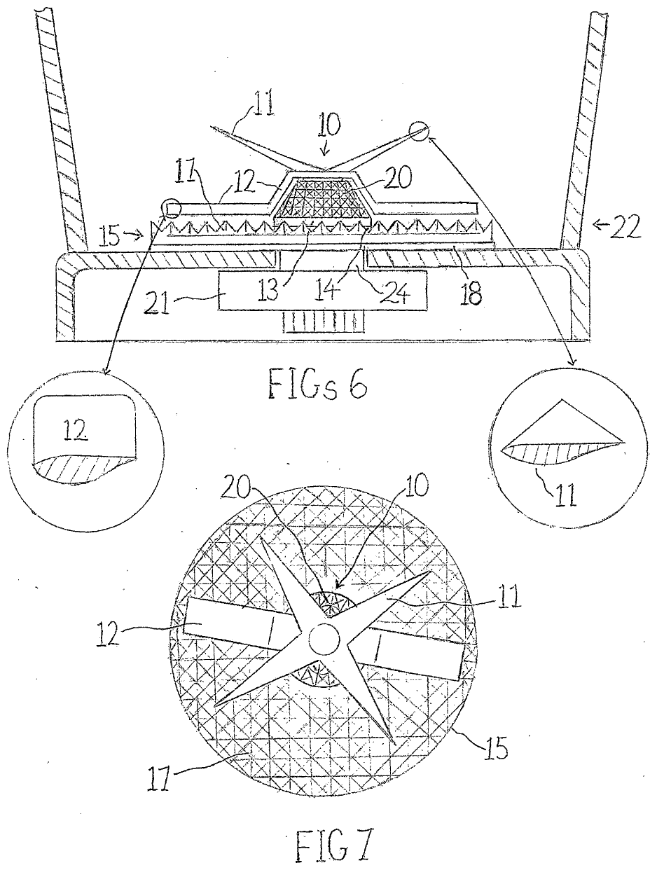

FIG. 5 shows from top to bottom; a perspective view of a blade assembly 10 having a head 13 with texture 20 of pyramid studs, two sets of blades; upper initial cut blades 11 and lower grinder blades 12, and a shaft portion 24 with threading and a drive gear at the bottom. Said shaft potion 24 of the blade assembly 10 extends first through a small gasket 14, then through a hole 16 in the center of a textured 17 grinder disc-like assembly 15. The texture 17 on the disk-like device 15 is a grid of small pyramid shape risings on the top surface; like those on the head 13 of the blade assembly 10, the bottom surface is, however, smooth. The shaft 24 of the blade assembly 10; is further fitted through the center 19 of a larger gasket 18 that covers the entire bottom surface of the disc device 15 and is flushed with its circumference. The remaining portion with the threading is then fitted through a hole 23 at the center of the blender jar 22 (seen from a broken away cross sectional side view). Therefore, the disc-like device 15, fitted between both gaskets 14 and 18, along with the head 13 of the blade assembly 10, which they are fitted beneath; are all assembled inside the jar 22 with only the threaded and gear portion of the shaft 24 extended outside beneath the jar 22 such that they are fixed in place by screwing on and tightening a bottom plate 21 (seen in FIG. 6) with inner threading for said threaded shaft 24 portion of the blade assembly 10.

FIG. 6 shows the parts identified in FIG. 5; assemble in the same order, they further include two exploded cross sectional end views of; the lower grinder blades 12 on the lower left, and the upper initial cutting blade 11 on the lower right. Both exploded views show that both sets of blades are sharpened from beneath such the while spinning they will force the mixture downwards towards the grinder disc assembly 15.

### Other Embodiment

In another version, the top of the blade assembly is of traditional design and does not have a wide top extending into a wavelike design, but instead the gradual raising/peak or wave portion of the wide circular upper portion of the blade assembly as described in the main embodiment; is a separate structure having a hole in the center for receiving the blade assembly. Specifically, this separate structure would have a half (along its length) cylinder shape with a hole in its center, which extends from the rounded side to the flat side. It would also have a square shaped gasket for the flat side that is flush with the outer edge.

### Other Embodiments

In other versions, the wide circular portion of the top of the blade assembly as described in the main embodiment, the textured disc device as described the alternative embodiment and half cylinder shape structure as described in the other embodiment; are all instead, in each version, an extension of the inner bottom surface of the blender jar. Specifically, in each of the above versions; the areas having a textured surface would, instead, be a molded continuation of the bottom of the inner jar. In this embodiment the jar would preferably be made of a nontoxic metallic material such as stainless steel.

1. I claim a type of blender that breaks down food my means of both chopping and grinding, it includes;
A. The inner bottom of the jar having a wavelike design or shaped structure,
B. Said wavelike structure has a high portion that is a peak and extends along a half line area of said bottom of said jar,
C. A shaft having at least one blade extends through the center of the jar and said wave-like structure and is connected to a drive shaft at the bottom of the said jar.
D. Said high portion has a gradual curve downwards on both sides and gradually tappers off into, or is connected, two lower flat portions; each on opposite sides of said high portion,
E. Said high portion is at a position such that; the top is close to the rotational path of at least one blade,
Whereby, whenever said at least one blade rotates and chops food; said food is cycled with a force along said low portion to said high portion of said wave structure; and whenever said at least one blade rotates and passes directly above said high portion; food is forced between both said blade and high portion, where it is further broken down by being grinded.

2. In claim 1 wherein said shaft has two blades, that is one strip of metal with a slight upward right-angle curve on both ends; and is connected to said shaft at its center.

3. In claim 1 wherein said wave-like structure is a continuation of the head of said blade assembly, specifically; the portion above the threading that sits inside the jar, said wavelike structure is circular with said high portion extending along its diameter, at said top of said high portion is a strip of flat area along its length and extends in an upward right angle curve on each end, such that they contours to the upward right-angle ends of the rotatable blades as described in claim 2, the surface of said flat area has texture along its length, said top of said high portion is just bigger in length than said rotatable blades as described in claim 2, said wavelike structure has a gasket that covers the bottom surface of said structure.

4. In claim 1 wherein said wavelike structure is a disk-like shape device that has an opening at its center and a round groove in the middle of said high portion; which surrounds said hole, and together with said hole; is for receiving said blade assembly, said high portion of said wavelike ring structure has ends each with a slight upwards right-angle curve, below said disk is a gasket that covers its bottom surface, and another gasket that sits in said groove around said opening.

5. In claim 1 wherein said wavelike structure is a continuation of said inner bottom surface of said jar and has an opening at its center and a round groove in the middle of said high portion; which surrounds said hole, and together with said hole; is for receiving said blade assembly, a gasket sits in said groove around said opening beneath said blade assembly

[symbol]

6. I claim a type of blender that breaks down food my means of both chopping and grinding, It includes;
A. A textured area or surface of the bottom of the blender jar that is in close proximity of the rotational path of at least one blade,
B. said textured area is close to said rotational path of said blades by; being on a gradual raised area such that food can be channel upwards between it and said blades,
C. or said textured area is on a level surface of said bottom of jar, and at least one said blade is at a low position and angled or has a bulge such that food is channeled downwards between it and said texture area.
D. Said textured area is either on; an extension of the head or top of a blade assembly, a device with an opening such that it is fitted beneath said blade assembly or an extension, or part of, of said surface of said bottom of said blender jar.

7. In claim 6 wherein said disc-like device is metallic, and said textured area/surface is on one side of said disc-like device having a hole at its center and a gasket that cover the entire surface of the other side; such that said gasket along with said disk is fitted on the bottom surface within the blender jar with the textured side facing upwards and a blade assembly fitted through said hole at the center; on opposite side of said disk is a small extension curved upwards at a right angle on the side of said texture.

8. In claim 6 wherein said blender blades amount to four; two slanted upwards, and two extends downwards such that their length; is in close proximity to, extends across, and is parallel to; said textured area on said disk, said blades also each has

[symbol]

9. [symbol] an right-angled curved upwards ends that contours to said curved upwards extension of said disc as described in claim 7, furthermore, said two blades that extends downwards; are each tapered along the edge to the direction of which they rotate, and each has a downwards bulge closer to the opposite edge along its length; such that, food chopped by said tapered end is driven downwards by said bulge; to said textured disc as described in claim 7.
